(19) United States
(12) Patent Application Publication
(10) Pub. No.: US 2008/0268126 A1
(43) Pub. Date: Oct. 30, 2008

(54) Non-dairy, no-sugar-added low calorie frozen dessert with smooth texture and method of preparing same

(76) Inventors: Clement Opawumi, Townsend, DE (US); Charles E. Kuenzle, Newark, DE (US)

Correspondence Address: TOD R NISSLE, PO BOX 55630, PHOENIX, AZ, 85078, US

(21) Appl. No.: 12/077,050

(22) Filed: Mar. 14, 2008

Related U.S. Application Data
(63) Continuation-in-part of application No. 11/986,303, filed on Nov. 20, 2007.
(60) Provisional application No. 60/860,125, filed on Nov. 20, 2006.

(51) Int. Cl. A23G 3/48; A23G 9/42; A23G 9/34; A23G 3/42

(52) U.S. Cl. 426/567; 426/572

(57) ABSTRACT

A method to produce a non-dairy, low calorie, no-sugar-added dessert having a smooth texture. The method includes the steps of providing ingredients including a maltitol syrup, fruit puree, fruit juice concentrate, water, polydextrose, at least one bulking agent, at least one stabilizer, and at least one high intensity sweetener; admixing the ingredients to produce a preliminary dessert composition; introducing air in said preliminary dessert composition to increase the volume of said composition by 30% to 70% and produce an aerated dessert composition; selecting a draw-up temperature in the range of zero degrees F. to twenty degrees F.; and, freezing the aerated dessert composition to said draw up temperature in five to twelve minutes.

This application claims priority based on patent application Ser. No. 11/986,303, filed Nov. 20, 2007, and based on the provisional patent application Ser. No. 60/860,125, filed in the United States Patent Office on Nov. 20, 2006.

This invention relates to a no-sugar-added (NSA) non-dairy, low calorie frozen dessert.

More particularly, the invention relates to a frozen desert of the type described which has a smooth consistency or texture.

Dairy-based, frozen desserts containing polyols blended with high intensity sweeteners are well known. In particular, ice cream compositions including 18% to 21% maltitol are known. Many of such ice cream desserts include traditional sucrose-corn syrup sweetener compositions.

We have discovered a frozen dessert composition and method for making the same that eliminates the need to utilize sucrose-corn syrup compositions and that produces, without the use of milk, a frozen dessert that has a smooth consistency or texture.

As used herein, the term frozen dessert refers to a frozen food preparation that is frozen during manufacture and that is intended to be consumed when removed from a freezer or refrigerator. Further, the food preparation is a fruit sorbet or sherbert.

In one preferred embodiment of the invention a method is provided to produce a non-dairy, low calorie, no-sugar-added dessert having a smooth texture. The method includes the steps of providing ingredients including a maltitol syrup having a molecular weight in the range of 540 to 580, and long chain fractions comprising at least 15% by weight of the maltitol syrup; fruit puree including 22% to 30% by weight fruit solids; fruit juice concentrate; water; polydextrose; at least one bulking agent from a group consisting of polyglycitol and maltodextrin having a DE in the range of 5 DE to 18 DE; at least one stabilizer; and, at least one high intensity sweetener. The foregoing ingredients are admixed to produce a preliminary dessert composition comprising 45% to 65% by weight water, 7% to 9% by weight maltitol syrup, 3% to 6% by weight polydextrose, 3% to 6% by weight bulking agent, 0.2% to 1.6% by weight stabilizer, 0.02% to 0.08% by weight high intensity sweetener, 10% to 18% by weight fruit puree, and 9.0% to 14.0% by weight fruit concentrate. Air is introduced in the preliminary dessert composition to increase the volume of the composition by 30% to 70% and produce an aerated dessert composition. A draw-up temperature in the range of zero degrees F. to twenty degrees F. is selected; and, the aerated dessert composition is frozen to the draw up temperature in five to twelve minutes.

In another preferred embodiment of the invention, provided is a non-dairy, low calorie, no-sugar-added dessert. The desert comprises 45% to 65% by weight water; 7% to 11% be weight of a maltitol syrup having a molecular weight in the range of 540 to 580, and long chain fractions comprising at least 15% by weight of the maltitol syrup; 10% to 18% by weight of a fruit puree including 22% to 30% by weight fruit solids; 9.0% to 14.0% by weight of a fruit concentrate; 3% to 6% by weight of polydextrose; 3% to 6% by weight of a bulking agent selected from a group consisting of polyglycitol and maltodextrin having a DE in the range of 5 DE to 18 DE; 0.1% to 1.6% by weight of at least one stabilizer; 0.02% to 0.08% by weight of at least one high intensity sweetener; and, 30% to 70% by volume air.

In still a further preferred embodiment of the invention, a non-dairy, low calories, no-sugar-added dessert is provided. The desert comprises 35% to 75% by weight water; 4% to 23% by weight of a maltitol syrup having a molecular weight in the range of 530 to 590, and long chain fractions comprising at least 10% by weight of the maltitol syrup; 5% to 18% by weight of a fruit puree including 22% to 30% by weight fruit solids; 1.0% to 14.0% by weight of a fruit concentrate; 2% to 10% by weight of polydextrose; 2% to 10% by weight of a bulking agent selected from a group consisting of polyglycitol and maltodextrin having a DE in the range of 5 DE to 18 DE ; 0.05% to 2.0% by weight of at least one stabilizer; 0.005% to 0.5% by weight of at least one high intensity sweetener; and, 20% to 70% by volume air. This dessert can be produced utilizing the method outlined above.

The discovery of the non-dairy dessert of the invention required the utilization of a variety of unexpected results, compositions, or processes. In part, these compositions and processes were required because of differences between the sorbet dessert of the invention and ice cream. Ice cream includes milk proteins, the sorbet dessert does not. The milk proteins help to produce the creamy texture of ice cream. Ice cream has a higher percentage total solids than that of the sorbet dessert of the invention. Ice cream typically includes sugar and corn syrup; the dessert of the invention does not. The foregoing differences between ice cream and the sorbet dessert of the invention make it difficult to produce a sorbet dessert that has a reasonable shelf life and that has a smooth consistency or texture comparable to ice cream. Compositions and processes developed in accordance with the invention are discussed below.

### Weight % Maltitol Syrup.

An 18% to 21% by weight concentration of maltitol typically is found in dairy ice cream. This concentration of maltitol is different in the non-dairy frozen dessert of this invention. The presently preferred concentration of maltitol in the completed frozen dessert is approximately 9% by weight.

### Ice Crystal Growth.

One of the principal, and difficult to achieve, goals of the invention was to produce a sorbet that had a smooth consistency with very small ice crystals formation. Such a consistency is achieved by minimizing the growth of ice crystals that form when the sorbet is frozen.
A. Rapid Freezing. One important way in which the growth of ice crystals is minimized in the practice of the invention is by quickly freezing the completed dessert product composition to a selected draw-up temperature. The draw-up temperature is in the range of 25 to −10 degrees F., preferably 20 to −5 degrees F., and most preferably 15 to 0 degrees F. The completed dessert product is quickly frozen to the draw-up temperature in four to fifteen minutes, preferably about seven to ten minutes.
B. Overrun. Another important way in which the growth of ice crystals is minimized is, after all of the ingredients are admixed to form a preliminary dessert composition, by utilizing overrun to increase the volume of the dessert by 30% to 70% of the volume of the preliminary dessert composition, preferably by 35% to 65% of the volume of the preliminary dessert composition. Any desired means can be utilized to incorporate air in the preliminary dessert composition, but presently air is incorporated by whipping the preliminary dessert composition in a typical Taylor ice cream freezer.
C. Maltitol Syrup. A further way in which the growth of ice crystals is minimized is by utilizing maltitol syrup. Maltitol syrup has been found to be particularly effective in minimizing ice crystal growth in the sorbet dessert of the invention.

### Long Chain Fractions in Maltitol Syrup.

Importantly, preferred maltitol syrups include at least 7.5%, preferably 15%, and most preferably at least 20% by weight of fractions that have a longer chain length than maltitol. Such “long chain” formulations are important in minimizing ice crystal growth in order to obtain a smooth dessert consistency.

TABLE I
Maltitol Syrups

| | | MS IC | | MS-M95 | | Other | |
|---|---|---|---|---|---|---|---|
| | Frz. Pt. | (Wght | FPF | (Wght | FPF | Maltitol | FPF |
| Fraction | Factor | %) | Contribution | %) | Contribution | (Wght %) | Contribution |
| HP-1 | 2.00 | 3.4 | 6.80 | 1.8 | 3.54 | 3.5 | 6.96 |
| HP-2 | 1.00 | 68.1 | 68.10 | 96.7 | 96.70 | 54.6 | 54.60 |
| HP-3 | 0.67 | 15.6 | 10.45 | 1.1 | 0.74 | 19.3 | 12.93 |
| HP-4 | | 2.0 | | 0.1 | | 0.9 | |
| HP-5 | | 2.2 | | 0.0 | | 3.5 | |
| HP-6 | | 1.2 | | 0.0 | | 3.9 | |
| HP-7 | | 1.0 | | 0.0 | | 3.1 | |
| HP-8 | | 0.5 | | 0.0 | | 2.0 | |
| HP-9 | | | | 0.0 | | 0.8 | |
| HP-10 | | | | 0.0 | | 0.0 | |
| HP-11 | | 5.9 | | 0.3 | | 8.5 | |
| | | 100.0 | 85.35 | 100.0 | 100.98 | 100.0 | 74.49 |
| Freezing | | | 0.85 | | 1.01 | | 0.74 |
| Point | | | | | | | |
| Factor | | | | | | | |

In Table I, the HP-2 fraction is maltitol; HP-1 is sorbitol; and so on. Each of the fractions other than the HP-1 and HP-2 fractions has a longer chain polyol polymer. The Maltisweet™ IC and other commercially available products are preferred in the practice of the invention because they contain a significant quantity of long chain fractions. The MS-M95 product is not preferred in the practice of the invention because it is very substantially comprised only of maltitol (HP-2).

### Freezing Point Factor of Maltitol Syrup

In addition to having a significant “long-chain” fraction, it is preferred that a maltitol syrup utilized in the invention have an FPF (freezing point factor) that is less than 1.00, preferably less than 0.90 but greater than 0.73. This is believed advantageous because the FPF of corn syrup (36 DE) is 0.73, and because an ingredient with a higher freezing point factor generally permits ice crystals to increase more quickly in size. The optimum FPF to achieve the optimum ice crystal formation is between 0.75 and 0.90. Table II lists the FPFs of some compositions utilized in frozen desserts.

TABLE II
Freezing Point Factors

| Ingredient | Freezing Point Factor (FPF) |
|---|---|
| Erythritol | 2.80 |
| Sorbitol | 1.90 |
| Lactitol | 1.00 |
| Sucrose | 1.00 |
| Maltitol | 0.85 |
| Corn Syrup (36DE) | 0.73 |
| Polyglycitol | 0.70 |
| Polydextrose | 0.63 |
| Maltodextrin | 0.20 |

### Molecular Weight of Maltitol Syrup

It has been found desirable for the maltitol syrup utilized in the frozen non-diary dessert of the invention to have a molecular weight that is comparable to the molecular weight of a conventional sucrose/corn syrup (36 DE). A conventional sucrose/corn syrup is about 12% by weight sucrose and 6% by weight corn syrup and has an average molecular weight of 560 grams/mole. The Maltisweet™ IC maltitol syrup (i.e., the MS IC set forth in Table I) presently preferred in the invention has an average molecular weight of 557 grams/moles. The molecular weight of the maltitol syrup is in the range of 530 to 590 grams/mole, preferably 540 to 580 grams per mole, more preferably 550 to 570 grams per mole, and most preferably 555 to 565 grams/mole. The molecular weight of the maltitol syrup affects the freezing rate as well as the percent total solids in the dessert composition.

### Weight % Solids in the Fruit Puree

The weight percent solids in the fruit puree is important and is 22% to 32% by weight, preferably 24% to 30% by weight, and most preferably 26% to 28% by weight.

### Total Weight % Solids in the Final Dessert Product

The total weight percent solids in the final frozen dessert product is important and is 24% to 32% by weight, preferably 26% to 30% by weight, and most preferably 27% to 29% by weight. The total weight percent solids are important to balance the water mobilization of the finished formula. It is also important for textural characteristics of the finished product. Maltitol Syrup (6.75%), Polydextrose (4.50%), Polyglycitol (4.50%), stabilizer (0.40%) and the grape juice concentrate (6.45%) all contributes to the total solids of the final product. Strawberry fruit puree (3.92%). The weight percent solids is ice cream ranges from 30% to 42%, depending on the fat content of the finished product.

### Water Content

The frozen sorbet dessert of the invention contains significantly more water than ice cream, which would suggest that it would freeze more quickly and therefore provide a shorter period of time for ice crystals to grow, which would limit the size of the ice crystals. In practice, however, it appears that although the sorbet dessert freezes more quickly than ice cream, it does not freeze that much more quickly. A desired ice cream-like smooth consistency or texture is obtained by incorporation of the compositions and processes described above. As used herein, a smooth consistency or texture comprises having an ice cream-like consistency including very small ice crystals and free of ice granules or crystals that are, as are grains of sand, easily individually detectable and distinguishable by touch or by the mouth. Dreyers or Breyers vanilla ice creams that contain at least 10% milk fat are examples of ice creams having an ice cream consistency.

### Polydextrose

The use polydextrose in the invention is important in balancing solids and water distribution.

### Polyglycitol

The use of polyglycitol in the invention is important in balancing solids and water distribution. Polyglycitol's functionalities are believed to compliment those of polydextrose, and polyglycitol provides low reactivity with other ingredients utilized in the frozen dessert.

### Stabilizer

Varieties of conventional stabilizers used singly or in combination in frozen desserts are well known and, consequently, a “shopping list” of stabilizers is not set forth herein. The stabilizer utilized in the frozen dessert of the invention is presently a blend of gums, guar, and pectin. One function of the stabilizer is to tie up water to extend the shelf life of the frozen dessert of the invention.

### Flavor/Color

A variety of conventional flavorings or colorants used singly or in combination in frozen desserts is well known and, consequently, a “shopping list” of flavorings or colorants is not set forth herein.

### High Intensity Sweetener

The frozen dessert of the invention does not include any added sugar. Any of a variety of well known conventional high intensity sweeteners is utilized such as, by way of example and not limitation, Sucralose, Acesulfame potassium.

Other ingredients that can be incorporated in the frozen dessert include, without limitation, fiber, acids, and minerals.

The following example is provided by way of demonstration, and not limitation, of the invention:

### EXAMPLE I

The following ingredients are provided:

| Ingredient | Weight (grams) |
|---|---|
| Water | 5484 |
| Maltisweet ™ IC maltitol syrup¹ | 900 |
| Polydextrose | 450 |
| Polyglycitol (Stabilite ™ SD30 Polyglycitol | 450 |
| Powder²) | |
| Stabilizer (TIC Dairy Blend 101-B³) | 40 |
| High Intensity Sweetener (Sucralose- | 6 |
| 25% Solution) | |
| Fruit Puree (Strawberry Puree Conc.- | 140 |
| Kerr 28 Brix⁴) | |
| Fruit Juice Concentrate (100% | 110 |
| White Grape Juice Concentrate) | |
| Flavor (Strawberry WONF) | 50 |
| Color (Red # 40) | 20 |

¹Corn Products Specialty Ingredients, 321 Cherry Lane, New Castle, DE 19720
²Corn Products Specialty Ingredients, 321 Cherry Lane, New Castle, DE 19720
³TIC GUMS, 4609 Richlynn Drive, Belcamp, MD 21017
⁴Kerr Concentrates, Inc. 2340 Hyacinth Street N.E., Salem, Oregon 97303-4095

The following production steps are followed:
1. Place water, Maltitol syrup and Sucralose into a mixing vessel.
2. Disperse the stabilizer slowly into the mixture under agitation to prevent clumping and promote better incorporation. Continue the agitation until homogenous.
3. Slowly add polydextrose and polyglycitol to the mixture. Mix thoroughly. (In some cases, stabilizer may be pre-blended with polydextrose and polyglycitol and added to the liquid mixture to facilitate full hydration and improve dispersion).
4. Pasteurize the mixture in step 3 using high-temperature-short-time (HTST) process (180 degrees F. or 82 degrees C. for 30 seconds).
5. Cool the mixture immediately to 38 degrees F., and place in mixing/holding vessel.
6. The strawberry fruit puree is admixed in the cooled mixture of step 5 to uniformity.
7. The white grape fruit juice concentrate is admixed in the mixture of step 6 to uniformity.
8. The Red #40 and Strawberry WONF flavor are admixed in the mixture of step 7 to uniformity.
9. The mixture of step 8 is aged for 10 hours at 38 degrees F.
10. The mixture of step 9 is processed (frozen using a batch freezer or a continuous freezer) to a 35% overrun by whipping to incorporate air to increase the volume of the mixture by an amount equal to 0.35 times the volume of the mixture of step 10.
11. The final product in step 10 is packed in containers and stored in a blast freezer (minus 40 degrees F.) for approximately 24 hours to rapidly freeze the finished product.

The foregoing process can be carried out by a batch process, a continuous process, or a combination of the two. The order of addition of the ingredients can also be varied to yield acceptable product depending upon the types of ingredients being blended together and their respective physical characteristics.

Having described our invention in such terms as to enable it to be made and used by those of skill in the art, we claim:

1. A method to produce a non-dairy, low calorie, no-sugar-added dessert having a smooth texture, comprising the steps of
(a) providing ingredients including
(i) a maltitol syrup having
a molecular weight in the range of 540 to 580,
long chain fractions comprising at least 15% by weight of said maltitol syrup, and
a FPF that is less than 1.00 and greater than 0.73;
(ii) fruit puree including 22% to 30% by weight fruit solids;
(iii) providing fruit juice concentrate;
(iv) providing water;
(v) providing polydextrose;
(vi) providing at least one bulking agent from a group consisting of polyglycitol and maltodextrin having a DE in the range of 5 DE to 18 DE;
(vii) at least one stabilizer;
(viii) providing at least one high intensity sweetener;
(b) admixing said ingredients to produce a preliminary dessert composition comprising
(i) 45% to 65% by weight of said water,
(ii) 7% to 9% by weight of said maltitol syrup,
(iii) 3% to 6% by weight of said polydextrose,
(iv) 3% to 6% by weight of said bulking agent,
(v) 0.2% to 0.6% by weight of said stabilizer,
(vi) 0.02% to 0.08% by weight of said high intensity sweetener,
(vii) 10% to 18% by weight of said fruit puree, and
(viii) 9.0% to 14.0% by weight of said fruit concentrate;
(c) introducing air in said preliminary dessert composition to increase the volume of said composition by 30% to 70% and produce an aerated dessert composition;
(d) selecting a draw-up temperature in the range of zero degrees F. to twenty degrees F.; and,
(e) freezing said aerated dessert composition to said draw up temperature in five to twelve minutes.

2. A non-dairy, low calorie, no-sugar-added dessert comprising
(a) 45% to 65% by weight water;
(b) 4% to 23% be weight of a maltitol syrup having
(i) a molecular weight in the range of 540 to 580,
(ii) long chain fractions comprising at least 15% by weight of said maltitol syrup, and
(iii) a FPF that is in the range of 0.75 to 0.90;
(c) 10% to 18% by weight of a fruit puree including 22% to 30% by weight fruit solids;
(d) 9.0% to 14.0% by weight of a fruit concentrate;
(e) 2% to 10% by weight of polydextrose;
(f) 2% to 10% by weight of a bulking agent selected from a group consisting of polyglycitol and maltodextrin having a DE in the range of 5 DE to 18 DE;
(g) 0.1% to 1.0% by weight of at least one stabilizer;
(h) 0.02% to 0.08% by weight of at least one high intensity sweetener; and,
(i) 30% to 70% by volume air.
